(19) United States
(12) Patent Application Publication
(10) Pub. No.: US 2012/0206217 A1
(43) Pub. Date: Aug. 16, 2012

(54) Band-Elimination Filter

(75) Inventors: Takahiro Okada, Nagaokakyo-shi (JP); Hideki Tsukamoto, Nagaokakyo-shi (JP); Hitoshi Tada, Nagaokakyo-shi (JP)

(73) Assignee: Murata Manufacturing Co., Ltd.

(21) Appl. No.: 13/368,485

(22) Filed: Feb. 8, 2012

(30) Foreign Application Priority Data
Feb. 14, 2011 (JP) 2011-028398

(51) Int. Cl. H01P 1/205

(52) U.S. Cl. 333/202; 333/206

(57) ABSTRACT

A band-elimination filter (BEF) that includes a coaxial dielectric resonator block, a substrate, and first, second, and third inductance elements. The coaxial dielectric resonator block includes inner conductors and an outer conductor, and forms coaxial dielectric resonators. The first inductance element is between a signal transmission path connected to one of the coaxial dielectric resonators via a series resonant capacitor and a signal transmission path connected to the other one of the coaxial dielectric resonators via a series resonant capacitor. The second inductance element is between one end of the first inductance element and the ground, and the third inductance elements is between the other end of the first inductance element and the ground.

### BACKGROUND OF THE INVENTION

1. Field of the Invention

The present invention relates to a band-elimination filter.

2. Description of the Related Art

Band-elimination filters (BEFs) using coaxial dielectric resonators have been used (see, for example, Japanese Unexamined Patent Application Publication No. 07-336109).

FIG. 1A is an exploded perspective view illustrating an exemplary module configuration of a BEF in the related art.

A BEF 101 includes a coaxial dielectric resonator block 102, a multilayer substrate 103, an inductance element 104, and a cover 105.

The coaxial dielectric resonator block 102 includes a block body 102A, inner conductors 102B, an outer conductor 102C, and terminal electrodes 102D, and forms two coaxial dielectric resonators R1 and R2. The block body 102A is formed in the shape of a substantially rectangular parallelepiped made of a dielectric material, and includes two through holes extending from a block front surface to a block back surface. The inner conductors 102B are individually formed on the inner surfaces of the through holes. The outer conductor 102C is formed on block outer surfaces other than the block front surface. The terminal electrodes 102D are formed on a block bottom surface so that they are apart from the outer conductor 102C and individually face the vicinities of the open ends of the inner conductors 102B.

The multilayer substrate 103 includes a substrate body 103A, a ground electrode 103B, resonator connection electrodes 103C, signal transmission paths 103D and 103E, and internal wiring lines (not illustrated). On the substrate body 103A, the coaxial dielectric resonator block 102, the inductance element 104, and the cover 105 are mounted. The ground electrode 103B is formed on the upper surface of the substrate body 103A, and is connected to the outer conductor 102C of the coaxial dielectric resonator block 102. The resonator connection electrodes 103C are formed on the upper surface of the substrate body 103A, and are individually connected to the terminal electrodes 102D of the coaxial dielectric resonator block 102. The signal transmission paths 103D and 103E are formed on the upper surface of the substrate body 103A so that the distal end portions of them have a spacing therebetween, and are individually connected to the resonator connection electrodes 103C via the internal wiring lines.

The inductance element 104 is disposed between the distal end portions of the signal transmission paths 103D and 103E. The cover 105 is disposed so that space in which the block front surface of the coaxial dielectric resonator block 102 and the inductance element 104 are exposed is formed and a short circuit is made between the outer conductor 102C on a block upper surface and the ground electrode 103B.

FIG. 1B is an equivalent circuit diagram of the BEF 101.

The BEF 101 includes an inductor L connected in series between an input terminal IN and an output terminal OUT. The input terminal IN is disposed on the side of the proximal end of the signal transmission path 103D, and the output terminal OUT is disposed on the side of the proximal end of the signal transmission path 103E. The inductor L is formed of the inductance element 104. A point of connection between the input terminal IN and the inductor L is connected to the ground via a capacitor C3, and is also connected to the ground via a series circuit including a capacitor Ce1 and the coaxial dielectric resonator R1. A point of connection between the output terminal OUT and the inductor L is connected to the ground via a capacitor C4, and is also connected to the ground via a series circuit including a capacitor Ce1 and the coaxial dielectric resonator R2. The capacitors Ce1 and Ce2 are provided between one of the inner conductors 102B and one of the terminal electrodes 102D and between the other one of the inner conductors 102B and the other one of the terminal electrodes 102D. The capacitors C3 and C4 correspond to stray capacitances at internal wiring lines (not illustrated). The capacitors C3 and C4 and the inductor L function as a phase-shift circuit, the coaxial dielectric resonator R1 and the capacitor Ce1 function as a series resonance circuit, and the coaxial dielectric resonator R2 and the capacitor Ce2 function as a series resonance circuit.

### SUMMARY OF THE INVENTION

The values of the coaxial dielectric resonators R1 and R2 and the values of the capacitors Ce1 and Ce2 are determined in accordance with the structure of the coaxial dielectric resonator block 102, and the values of the capacitors C3 and C4 are determined in accordance with the structure of the multilayer substrate 103. Accordingly, in order to adjust a filter characteristic, it is necessary to replace the inductance element 104 or change the structure of the coaxial dielectric resonator block 102 or the multilayer substrate 103. It is therefore difficult to minutely set a filter characteristic. In particular, it is difficult to improve a characteristic in a pass band lower than a signal removal band, and the degree of reflection and a passing loss are increased in a lower-frequency pass band.

It is an object of the present invention to provide a band-elimination filter for which a filter characteristic can be minutely set.

A band-elimination filter according to an embodiment of the present invention includes a coaxial dielectric resonator block, a substrate, and first, second, and third inductance elements. The coaxial dielectric resonator block includes a block body that is formed in a shape of a substantially rectangular parallelepiped mainly formed of a dielectric and has first and second through holes extending from a block front surface to a block back surface, first and second inner conductors that are individually formed on inner surfaces of the first and second through holes, and an outer conductor formed on block outer surfaces other than at least the block front surface. The substrate includes a substrate body having an upper surface on which the coaxial dielectric resonator block is mounted, a ground electrode that is formed on the upper surface of the substrate body and is connected to the outer conductor, a first signal transmission path that is formed on the upper surface of the substrate body and is connected to the first inner conductor via a first series resonant capacitor, and a second signal transmission path that is formed on the upper surface of the substrate body and is connected to the second inner conductor via a second series resonant capacitor. The first inductance element is disposed between the first signal transmission path and the second signal transmission path. The second inductance element is disposed between the first signal transmission path and the ground electrode. The third inductance element is disposed between the second signal transmission path and the ground electrode.

In this circuit configuration, the first inner conductor and the outer conductor form a first resonator and the second inner conductor and the outer conductor form a second resonator. The first signal transmission path and the ground electrode form a stray capacitor, the second signal transmission path and the ground electrode form a stray capacitor, and the stray capacitors and the first to third inductance elements form a phase-shift circuit. The phase-shift circuit, the first and second resonators, and the first and second series resonant capacitors form a band-elimination filter. Accordingly, the filter characteristic of the band-elimination filter can be adjusted by changing at least one of the inductance values of the first to third inductance elements. In particular, by disposing the second and third inductance elements, the improvement of a characteristic can be achieved on a side of frequencies lower than a signal removal band. In a lower-frequency pass band, the degree of reflection and a passing loss can be therefore reduced.

The band-elimination filter preferably further includes a first capacitance element disposed between the first inner conductor and the first signal transmission path as the first series resonant capacitor and a second capacitance element disposed between the second inner conductor and the second signal transmission path as the second series resonant capacitor.

The coaxial dielectric resonator block preferably further includes first and second terminal electrodes that are apart from the outer conductor, face vicinities of open ends of the first and second inner conductors, respectively, and are at least partly formed on the block front surface. The first series resonant capacitor is preferably formed between the first terminal electrode and the first inner conductor, and the second series resonant capacitor is preferably formed between the second terminal electrode and the second inner conductor.

In these configurations, the first series resonant capacitor can be controlled by replacing the first capacitance element, or cropping or trimming a region of the first terminal electrode on the block front surface and the second series resonant capacitor can be controlled by replacing the second capacitance element, or cropping or trimming a region of the second terminal electrode on the block front surface. Accordingly, it is possible to easily set a frequency in the signal removal band and adjust a filter characteristic.

In the band-elimination filter, the first and second signal transmission paths are preferably coplanar waveguides formed on an upper surface of a single-layered substrate.

In this configuration, a circuit area and a mounting height can be reduced as compared with a multilayer substrate in the related art.

In the band-elimination filter, the first to third inductance elements are preferably at least on of chip inductors and printed inductors.

In this configuration, a filter characteristic can be easily adjusted by replacing at least one of the chip inductors, or cropping or trimming at least one of the printed inductors.

According to an embodiment of the present invention, the filter characteristic of a band-elimination filter can be adjusted by changing at least one of the inductance values of the first to third inductance elements. In particular, by disposing at least one of the second and third inductance elements, the improvement of a characteristic can be achieved on a side of frequencies lower than a signal removal band. In a lower-frequency pass band, the degree of reflection and a passing loss can be therefore reduced.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1A is an exploded perspective view illustrating an exemplary module configuration of a band-elimination filter in the related art;

FIG. 1B is an equivalent circuit diagram of the band-elimination filter illustrated in FIG. 1A;

FIG. 2A is an exploded perspective view illustrating the module configuration of a band-elimination filter according to a first embodiment of the present invention;

FIG. 2B is an equivalent circuit diagram of the band-elimination filter illustrated in FIG. 2A;

FIG. 3A is a diagram describing the reflection characteristic of the band-elimination filter illustrated in

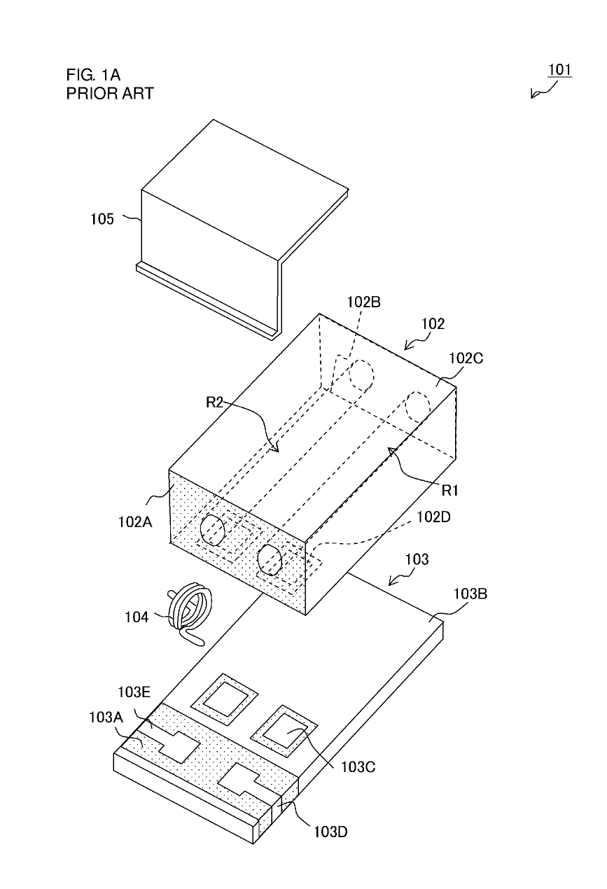

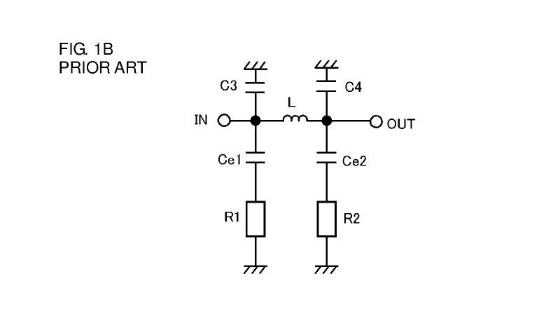

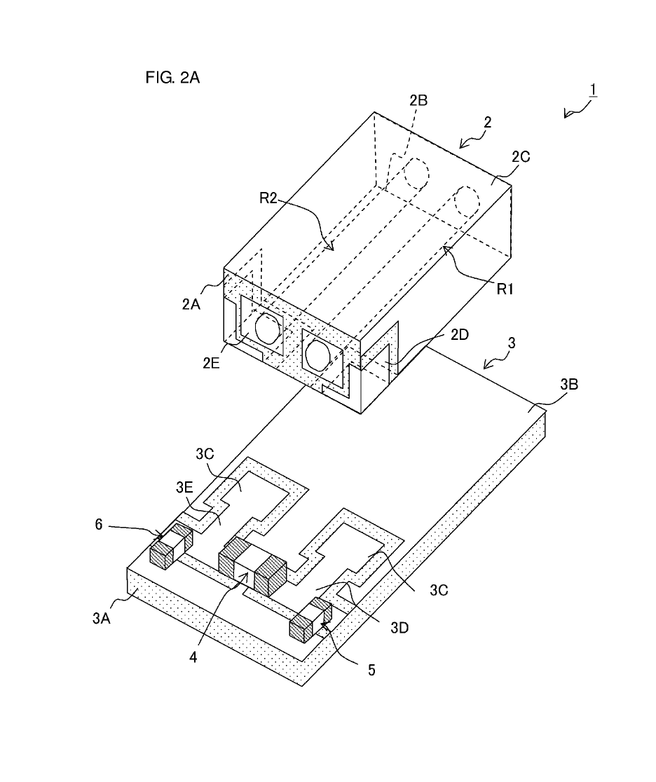

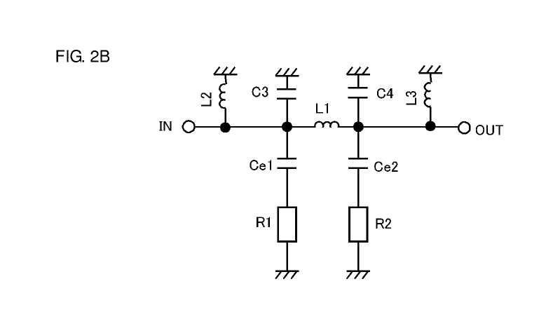

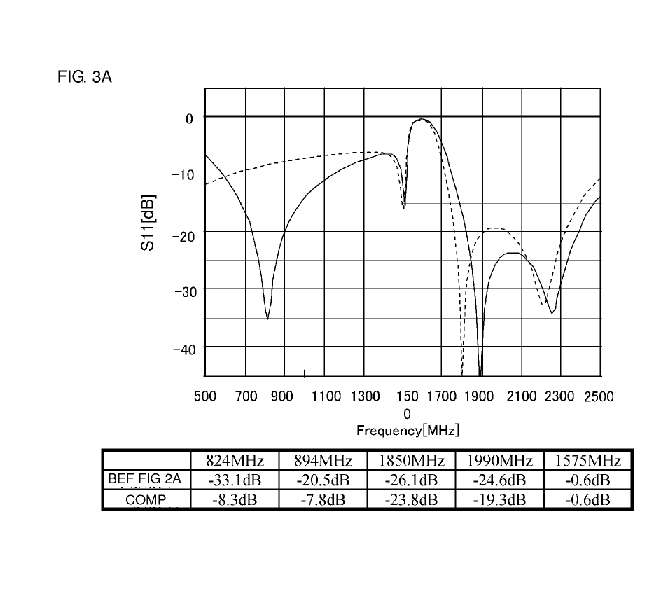

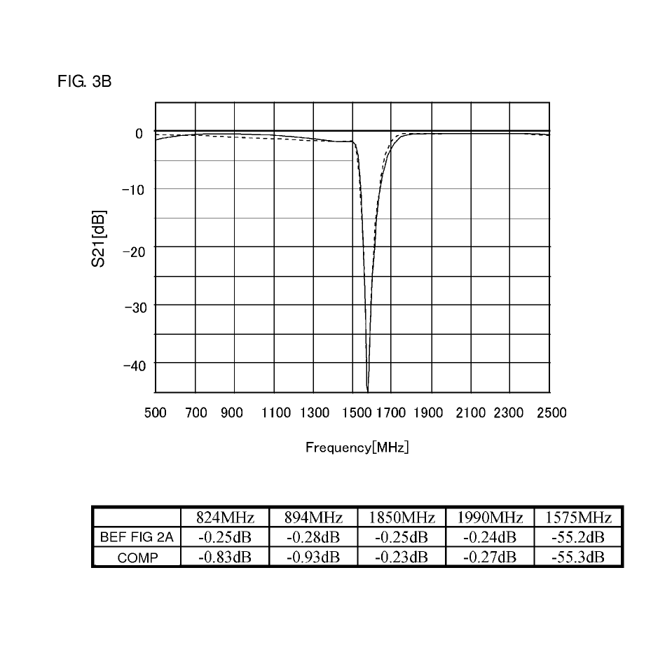

FIG. 2A which is changed in accordance with the presence of additional inductance elements;

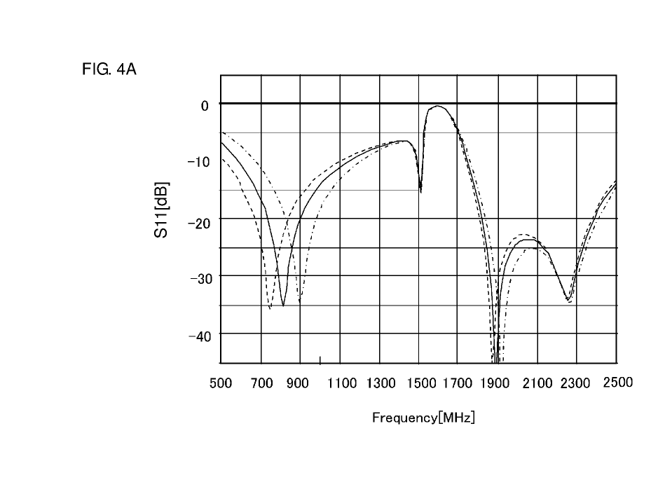

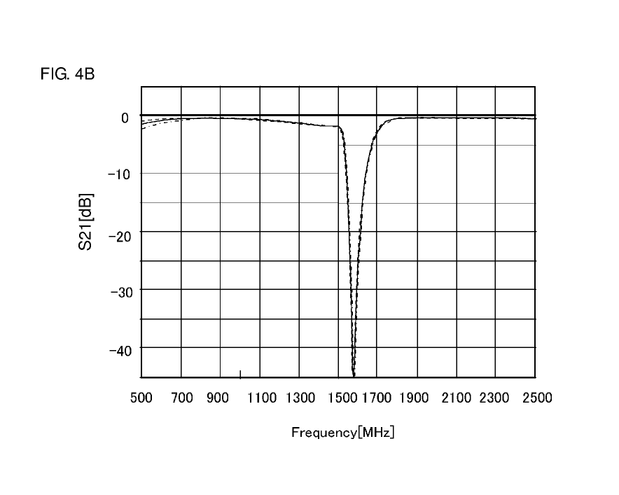

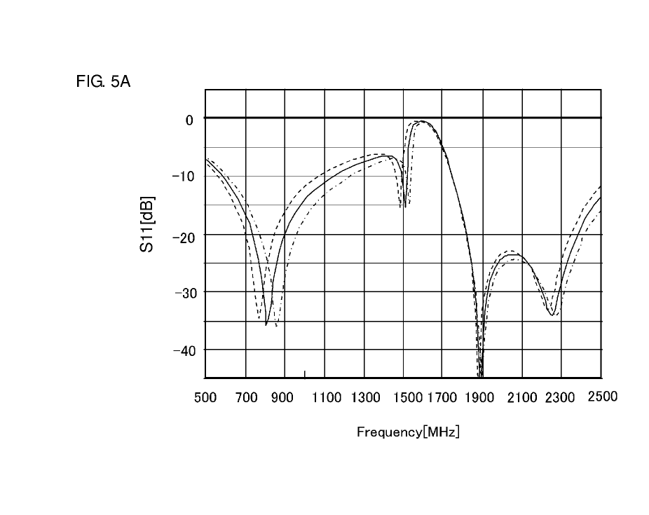

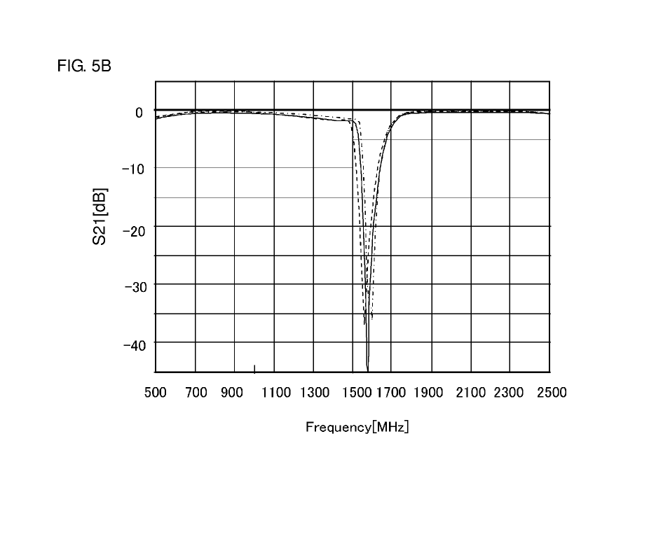

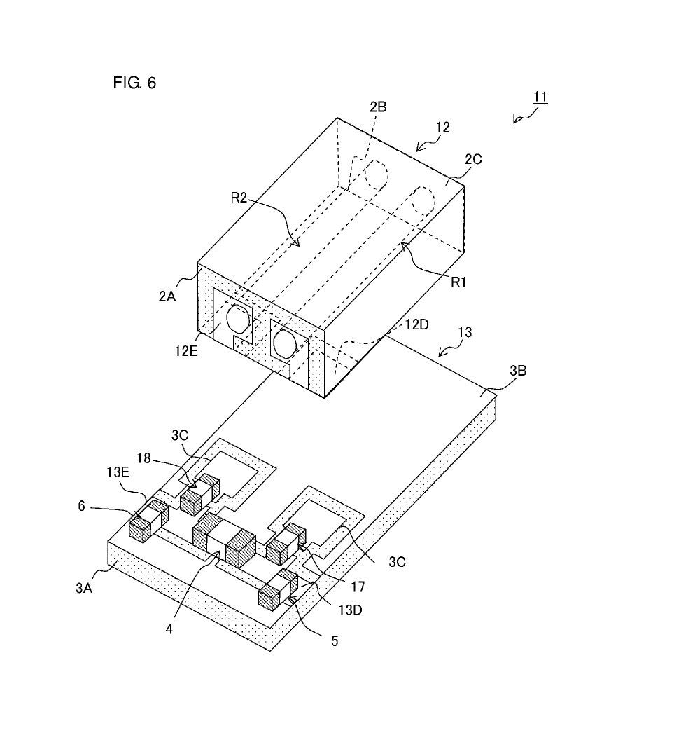

FIG. 3B is a diagram describing the transmission characteristic of the band-elimination filter illustrated in FIG. 2A which is changed in accordance with the presence of additional inductance elements;

FIG. 4A is a diagram describing the reflection characteristic of the band-elimination filter illustrated in FIG. 2A which is changed in accordance with the inductance values of additional inductance elements;

FIG. 4B is a diagram describing the transmission characteristic of the band-elimination filter illustrated in FIG. 2A which is changed in accordance with the inductance values of additional inductance elements;

FIG. 5A is a diagram describing the reflection characteristic of the band-elimination filter illustrated in FIG. 2A which is changed in accordance with the capacitance values of series resonant capacitors;

FIG. 5B is a diagram describing the transmission characteristic of the band-elimination filter illustrated in FIG. 2A which is changed in accordance with the capacitance values of series resonant capacitors; and

FIG. 6 is an exploded perspective view illustrating the module configuration of a band-elimination filter according to a second embodiment of the present invention.

### DESCRIPTION OF THE PREFERRED EMBODIMENTS

### First Embodiment

A band-elimination filter (BEF) according to the first embodiment having an attenuation band around 1500 MHz for the Global Positioning System (GPS) and having a pass band in an 800 MHz band and a 1900 MHz band for a mobile communication network will be described below by way of example.

FIG. 2A is an exploded perspective view illustrating the module configuration of a BEF 1 according to the first embodiment.

The BEF 1 includes a coaxial dielectric resonator block 2, a substrate 3, and inductance elements 4, 5, and 6.

The coaxial dielectric resonator block 2 includes a block body 2A, inner conductors 2B, an outer conductor 2C, terminal electrodes 2D, and open-surface electrodes 2E, and forms two quarter-wave coaxial dielectric resonators R1 and R2. The block body 2A is formed in the shape of a substantially rectangular parallelepiped (for example approximately 7 mm×approximately 4 mm×approximately 1.5 mm) made of a dielectric material, and includes two through holes extending from a block front surface to a block back surface. The inner conductors 2B are individually formed on the inner surfaces of the through holes. The outer conductor 2C is formed on block outer surfaces other than the block front surface. The terminal electrodes 2D extend to a block bottom surface, block side surfaces, and the block front surface so that they are apart from the outer conductor 2C and individually face the vicinities of open ends of the inner conductors 2B. The open-surface electrodes 2E are substantially rectangular electrodes that are formed on the block front surface and are individually connected to the inner conductors 2B.

The substrate 3 includes a substrate body 3A, a ground electrode 3B, resonator connection electrodes 3C, and signal transmission paths 3D and 3E. On the substrate body 3A, the coaxial dielectric resonator block 2 is mounted. The ground electrode 3B is formed on the upper surface of the substrate body 3A, and is connected to the outer conductor 2C of the coaxial dielectric resonator block 2. The resonator connection electrodes 3C are formed on the upper surface of the substrate body 3A, and are individually connected to the terminal electrodes 2D of the coaxial dielectric resonator block 2. The signal transmission paths 3D and 3E are coplanar waveguides formed on the upper surface of the substrate body 3A, and are disposed so that the distal end portions of them have a spacing therebetween and they are individually connected to the resonator connection electrodes 3C.

The inductance element 4 is disposed between the distal end portions of the signal transmission paths 3D and 3E. The inductance element 5 is disposed between the signal transmission path 3D and the ground electrode 3B. The inductance element 6 is disposed between the signal transmission path 3E and the ground electrode 3B. The inductance elements 4, 5, and 6 are chip inductors in this example, but may be air-cored coils or printed coils.

In the BEF 1 having the above-described configuration, the inductance values of the inductance elements 4, 5, and 6 can be changed by replacing them. A capacitance value obtained between the open-surface electrode 2E and the terminal electrode 2D can be changed by cropping or trimming the open-surface electrode 2E or a region of the terminal electrode 2D on the block front surface.

FIG. 2B is an equivalent circuit diagram of the BEF 1.

The BEF 1 includes an inductor L1 connected in series between an input terminal IN and an output terminal OUT. The input terminal IN is disposed on the side of the proximal end of the signal transmission path 3D, and the output terminal OUT is disposed on the side of the proximal end of the signal transmission path 3E. The inductor L1 is formed of the inductance element 4. A point of connection between the input terminal IN and the inductor L1 is connected to the ground via a capacitor C3, and is also connected to the ground via a series circuit including a capacitor Ce1 (series resonant capacitor) and the resonator R1. A point of connection between the output terminal OUT and the inductor L1 is connected to the ground via a capacitor C4, and is also connected to the ground via a series circuit including a capacitor Ce2 (series resonant capacitor) and the resonator R2. The capacitor Ce1 is provided between one of the terminal electrodes 2D and each of one of the inner conductors 2B and one of the open-surface electrodes 2E. The capacitor Ce2 is provided between the other one of the terminal electrodes 2D and each of the other one of the inner conductors 2B and the other one of the open-surface electrodes 2E. The capacitors C3 and C4 correspond to stray capacitances at, for example, the signal transmission paths 3D and 3E. The capacitors C3 and C4 and the inductors L1, L2, and L3 function as a phase-shift circuit, the resonator R1 and the capacitor Ce1 function as a series resonance circuit, and the resonator R2 and the capacitor Ce2 function as a series resonance circuit.

In this circuit configuration, the inductors L1, L2, and L3 and the capacitors Ce1 and Ce2 can be easily changed, and the filter characteristic of the BEF 1 can be therefore easily adjusted.

<First Comparative Test>

Here, the influence of the inductors L2 and L3 on the filter characteristic of the BEF 1 will be described. FIG. 3A is a diagram describing the reflection characteristic of the BEF 1 which is changed in accordance with the presence of the inductors L2 and L3. FIG. 3B is a diagram describing the transmission characteristic of the BEF 1 which is changed in accordance with the presence of the inductors L2 and L3. In the drawings, a solid line represents a characteristic obtained in the case of a configuration according to an embodiment of the present invention in which the inductors L2 and L3 are present, and a broken line represents a characteristic obtained in the case of a comparative configuration in which the inductors L2 and L3 are not present.

In the reflection characteristic illustrated in FIG. 3A, in the case of the configuration according to an embodiment of the present invention, a pole at which S11 was the smallest could be set in a signal removal band (around 1500 MHz), a lower-frequency signal pass band (around 800 MHz), and a higher-frequency signal pass band (around 1900 MHz). On the other hand, in the case of the comparative configuration, the pole at which S11 was the smallest could be set in the signal removal band, but markedly deviated from the lower-frequency signal pass band toward a lower-frequency side and deviated from the higher-frequency signal pass band toward a lower-frequency side.

In the transmission characteristic illustrated in FIG. 3B, in the case of both the configuration according to an embodiment of the present invention and the comparative configuration, a pole at which S21 was the smallest could be set in the signal removal band (around 1500 MHz). In the higher-frequency signal pass band (around 1900 MHz), in the case of both the configuration according to an embodiment of the present invention and the comparative configuration, substantially the same transmission characteristic could be achieved. However, in the lower-frequency signal pass band (around 800 MHz), in the case of the configuration according to an embodiment of the present invention, the amount of attenuation was smaller than that in the case of the comparative configuration and a better transmission characteristic could be achieved.

A result of the test indicates that the inductors L2 and L3 can improve a reflection characteristic and a transmission characteristic in the signal pass band lower than the signal removal band.

<Second Comparative Test>

Next, the influence of the change in the inductance values of the inductors L2 and L3 on the filter characteristic of the BEF 1 will be described. FIG. 4A is a diagram describing the reflection characteristic of the BEF 1 which is changed in accordance with the inductance values of the inductors L2 and L3. FIG. 4B is a diagram describing the transmission characteristic of the BEF 1 which is changed in accordance with the inductance values of the inductors L2 and L3. In the drawings, a solid line represents a characteristic obtained in the case of a first example in which the same inductance values as those obtained with the above-described configuration according to an embodiment of the present invention are used, a broken line represents a characteristic obtained in the case of a second example in which inductance values that are increased by 10% are used, and alternate long and short dashed lines represent a characteristic obtained in the case of a third example in which inductance values that are reduced by 10% are used.

In the reflection characteristic illustrated in FIG. 4A, in the case of all of the examples, a pole at which S11 was the smallest could be set in the signal removal band (around 1500 MHz), the lower-frequency signal pass band (around 800 MHz), and the higher-frequency signal pass band (around 1900 MHz). The pole in the signal removal band was not changed even when the inductance values were changed. However, the poles in the lower-frequency signal pass band and the higher-frequency signal pass band moved toward a lower-frequency side when the inductance values were increased and moved toward a higher-frequency side when the inductance values were reduced. A result of the test indicates that the reflection characteristic of the BEF 1 can be adjusted in the higher-frequency signal pass band and the lower-frequency signal pass band by disposing the inductors L2 and L3 and adjusting the inductance values of the inductors L2 and L3.

In the transmission characteristic illustrated in FIG. 4B, in the case of all of the examples, a pole at which S21 was the smallest could be set in the signal removal band (around 1500 MHz). In the lower-frequency signal pass band (around 800 MHz) and the higher-frequency signal pass band (around 1900 MHz), a good transmission characteristic in which there was little change in the amount of attenuation could be achieved. A result of the test indicates that a good transmission characteristic of the BEF 1 can be maintained even when the inductors L2 and L3 are disposed and the inductance values of the inductors L2 and L3 are adjusted.

<Third Comparative Test>

Next, the influence of the change in the capacitance values of the capacitors Ce1 and Ce2 on the filter characteristic of the BEF 1 will be described. FIG. 5A is a diagram describing the reflection characteristic of the BEF 1 which is changed in accordance with the capacitance values of the capacitors Ce1 and Ce2. FIG. 5B is a diagram describing the transmission characteristic of the BEF 1 which is changed in accordance with the capacitance values of the capacitors Ce1 and Ce2. In the drawings, a solid line represents a characteristic obtained in the case of a fourth example in which the same capacitance values as those obtained with the above-described configuration according to an embodiment of the present invention are used, a broken line represents a characteristic obtained in the case of a fifth example in which capacitance values that are increased by 10% are used, and alternate long and short dashed lines represent a characteristic obtained in the case of a sixth example in which capacitance values that are reduced by 10% are used.

In the reflection characteristic illustrated in FIG. 5A, in the case of all of the examples, a pole at which S11 was the smallest could be set in the signal removal band (around 1500 MHz), the lower-frequency signal pass band (around 800 MHz), and the higher-frequency signal pass band (around 1900 MHz). The frequency of the pole was not significantly changed in the higher-frequency signal pass band even when the capacitance values were changed. On the other hand, the poles in the lower-frequency signal pass band and the signal removal band moved toward a side of frequencies lower than the frequency of the pole obtained in the fourth example in the fifth example in which the capacitance values are increased, and moved toward a side of frequencies higher than the frequency of the pole obtained in the fourth example in the sixth example in which the capacitance values are reduced. A result of the test indicates that the reflection characteristic of the BEF 1 can be adjusted in the lower-frequency signal pass band and the signal removal band by disposing open-surface electrodes and terminal electrodes which are capable of being cropped or trimmed.

In the transmission characteristic illustrated in FIG. 5B, in the case of all of the examples, in the lower-frequency signal pass band (around 800 MHz) and the higher-frequency signal pass band (around 1900 MHz), a good transmission characteristic in which there was little change in the amount of attenuation could be achieved. The pole in the signal removal band (around 1500 MHz) moved toward a side of frequencies lower than the frequency of the pole obtained in the fourth example in the fifth example in which the capacitance values are increased, and moved toward a side of frequencies higher than the frequency of the pole obtained in the fourth example in the sixth example in which the capacitance values are reduced. A result of the test indicates that the frequency in the signal removal band can be adjusted while maintaining a good transmission characteristic of the BEF 1 in the lower-frequency signal pass band and the higher-frequency signal pass band by disposing open-surface electrodes and terminal electrodes which are capable of being cropped or trimmed.

As is apparent from the above-described comparative tests, in the case of the configuration according to an embodiment of the present invention in which the values of the inductors L2 and L3 and the values of the capacitors Ce1 and Ce1 can be adjusted, the reflection characteristic and transmission characteristic of the BEF 1 can be set with a high degree of flexibility.

### Second Embodiment

Next, a band-elimination filter according to the second embodiment of the present invention will be described. FIG. 6 is an exploded perspective view illustrating the module configuration of a BEF 11 according to the second embodiment of the present invention.

The BEF 11 includes a coaxial dielectric resonator block 12, a substrate 13, the inductance elements 4, 5, and 6, and capacitance elements 17 and 18.

The coaxial dielectric resonator block 12 includes the block body 2A, the inner conductors 2B, the outer conductor 2C, terminal electrodes 12D, and open-surface electrodes 12E, and forms the two quarter-wave coaxial dielectric resonators R1 and R2. The terminal electrodes 12D are formed on a block bottom surface so that they are apart from the outer conductor 2C. The open-surface electrodes 12E are individually connected to the inner conductors 2B and the terminal electrodes 12D and are formed on a block front surface.

The substrate 13 includes the substrate body 3A, the ground electrode 3B, the resonator connection electrodes 3C, and signal transmission paths 13D and 13E. The signal transmission paths 13D and 13E are formed on the upper surface of the substrate body 3A so that the distal end portions of them have a spacing therebetween and they are apart from the resonator connection electrodes 3C.

The capacitance element 17 is disposed between the signal transmission path 13D and one of the resonator connection electrodes 3C, and the capacitance element 18 is disposed between the signal transmission path 13E and the other one of the resonator connection electrodes 3C.

Since the capacitors Ce1 and Ce1 are formed of chip capacitance elements in the BEF 11 according to this embodiment, the capacitance values of the capacitors Ce1 and Ce2 can be changed by replacing the capacitance elements like in the case of the inductance elements 4, 5, 6.

The present invention is not limited to the above-described embodiments, and various changes can be made thereto. For example, a two (or more) stage series resonance circuit may be used.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A band-elimination filter comprising:
a coaxial dielectric resonator block having first and second through holes extending from a block first surface to a block second surface, first and second inner conductors on surfaces of the first and second through holes, respectively, and an outer conductor on at least one surface of the coaxial dielectric resonator block other than at least the block first surface;
a substrate having a first substrate surface on which the coaxial dielectric resonator block is mounted, a ground electrode on the first substrate surface and connected to the outer conductor, a first signal transmission path on the first substrate surface and connected to the first inner conductor via a first series resonant capacitor, and a second signal transmission path on the first substrate surface and connected to the second inner conductor via a second series resonant capacitor;
a first inductance element between the first signal transmission path and the second signal transmission path;
a second inductance element between the first signal transmission path and the ground electrode; and
a third inductance element between the second signal transmission path and the ground electrode.

2. The band-elimination filter according to claim 1, further comprising:
a first capacitance element between the first inner conductor and the first signal transmission path as the first series resonant capacitor; and
a second capacitance element between the second inner conductor and the second signal transmission path as the second series resonant capacitor.

3. The band-elimination filter according to claim 1,
wherein the coaxial dielectric resonator block further includes first and second terminal electrodes that are apart from the outer conductor, face vicinities of open ends of the first and second inner conductors, respectively, and at least partly extend onto the block first surface, and
wherein the first series resonant capacitor is between the first terminal electrode and the first inner conductor, and the second series resonant capacitor is between the second terminal electrode and the second inner conductor.

4. The band-elimination filter according to claim 1, wherein the first and second signal transmission paths are coplanar waveguides.

5. The band-elimination filter according to claim 4, wherein the coplanar waveguides are on the first substrate surface.

6. The band-elimination filter according to claim 1, wherein the first, second and third inductance elements are at least one of chip inductors and printed inductors.
